(19) United States
(12) Patent Application Publication
(10) Pub. No.: US 2014/0175239 A1
(43) Pub. Date: Jun. 26, 2014

(54) Sports Ball Holder

(71) Applicant: William Anthony Samples, Rantoul, IL (US)

(72) Inventor: William Anthony Samples, Rantoul, IL (US)

(21) Appl. No.: 13/726,494

(22) Filed: Dec. 24, 2012

(51) Int. Cl. F16M 13/02

(52) U.S. Cl. CPC F16M 13/02
USPC 248/205.1

(57) ABSTRACT

ABSTRACT OF THE DISCLOSURE: The sports ball holder is a mechanism for supporting a single sports ball (basketball, football, soccer ball, volleyball, kick ball, etc.) to a wall. The sports ball holder is fundamentally a single length of thick rounded metal formed into a loop with an extending member. The end of the extending member is threaded—like a screw—to form a screw-type fastener. The screw-type fastener is what supports the sports ball holder to the wall. The metal loop has an inside diameter smaller than the maximum diameter of a sports ball (basketball, football, soccer ball, volleyball, kick ball, etc.) to support the sports ball. The sports ball holder must be screwed into a solid material, like a wall stud, for strong support. The simple design of this sports ball holder embodiment makes the sports ball holder more practical to manufacture, package, and install than the prior arts.

OPERATION: The entire sports ball holder mechanism will be spun into a wall stud and mounted in the horizontal position. The built in screw-type fastener will strongly secure the sports ball holder to the wall. An individual sports ball can now be placed on and off the sports ball holder at will.

### CROSS-REFERENCE TO RELATED APPLICATIONS

None.

### FEDERALLY SPONSORED RESEARCH

None.

### REFERENCE TO SEQUENCE LISTING, A TABLE, OR A COMPUTER PROGRAM LISTING COMPACT DISC

None.

### BACKGROUND OF THE INVENTION

This application claims priority from U.S. Provisional Application, application No. 61/582,361, filed on Jan. 1, 2012. Most American households have their sports balls (basketballs, footballs, soccer balls, volleyballs, kick balls, etc.) rolling on the floor without a storage solution. In a large gymnasium setting, often a large mobile rack is used to transport and store sports balls. A sports ball rack of this magnitude is impractical for the average consumer. Other wall-mounted sports ball holders that exist require a large complicated system to be installed. Other wall-mounted sports ball holders that exist are often larger than needed. Families need a practical storage solution for holding a single sports ball (basketball, football, soccer ball, volleyball, kick ball, etc.) to a wall. The prior arts are more complicated to manufacture and therefore more expensive to produce and install. This patent describes a sports ball holder embodiment that is more practical to manufacture, install, and use than the prior arts.

### BRIEF SUMMARY OF THE INVENTION

The sports ball holder is a mechanism for supporting a single sports ball (basketball, football, soccer ball, volleyball, kick ball, etc.) on a wall. This sports ball holder embodiment is simple to manufacture, install, and use. It will prevent sports balls from rolling on floors—minimizing injury to persons and property. The sports ball holder will protect the sports ball from damage and prolong its life. The sports ball holder will keep the sports ball clean and ready for use. The sports ball holder will be used to display a sports ball for decorative purposes. This sports ball holder embodiment is more practical to manufacture, package, distribute, and install.

### BRIEF DESCRIPTION OF THE DRAWINGS

FIG. 1 is a perspective view taken from the top of the sports ball holder.

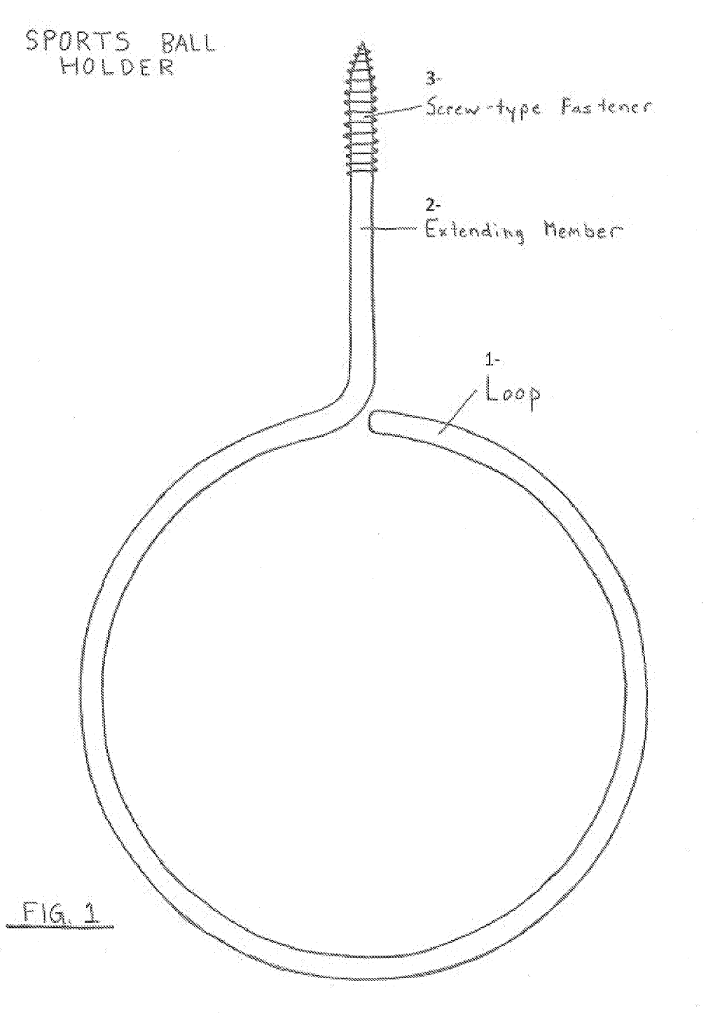

### REFERENCED NUMERALS

1—Loop or Ring
2—Extending Member
3—Screw-type Fastener

The sports ball holder is fundamentally a single length of thick rounded metal formed into a loop with an extending member. The end of the extending member (2) is threaded—like a screw—to form a screw-type fastener (3). The screw-type fastener is what supports the sports ball holder to the wall. The metal loop (1) has an inside diameter smaller than the maximum diameter of a sports ball (basketball, football, soccer ball, volleyball, kick ball, etc.) to support the sports ball. The sports ball holder must be screwed into a solid material, like a wall stud, for strong support.

### DETAILED DESCRIPTION OF THE INVENTION

The sports ball holder is a storage solution for holding a single sports ball (basketball, football, soccer ball, volleyball, kick ball, etc.) to a wall. The sports ball holder embodiment is comprised of a metal loop with an extending member. The end of the extending member is threaded with a screw-type fastener for securing the holder to the wall. Once the sports ball holder is screwed into a wall stud, the sports ball holder will support itself to the wall. The metal loop will support a single sports ball. The sports ball holder embodiment is comprised of metal that is coated with paint or a durable material for further protective purposes and decorative purposes.

I claim:

1. A sports ball holder, a mechanism for holding a single sports ball to a wall, comprising:
a. a single length of thick rounded metal formed into a loop, with diameter of the loop smaller than the diameter of a sports ball (basketball, football, soccer ball, volleyball, kickball); and
b. an extending member; and
c. the end of the extending member is threaded with a screw-type fastener for securing the holder to the wall; and
d. the metal is coated with a durable material for protective purposes.
